(19) United States
(12) Patent Application Publication
(10) Pub. No.: US 2018/0022223 A1
(43) Pub. Date: Jan. 25, 2018

(54) VEHICLE POWER-SOURCE DEVICE AND CONTROL METHOD FOR VEHICLE POWER-SOURCE DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Hayato Fukushima, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/547,912

(22) PCT Filed: Feb. 4, 2016
(86) PCT No.: PCT/JP2016/053336

§ 371 Date: Aug. 1, 2017

(30) Foreign Application Priority Data
Feb. 5, 2015 (JP) 2015-020891

(51) Int. Cl. B60L 11/18

(52) U.S. Cl. CPC B60L 11/1811; B60L 2210/10

(57) ABSTRACT

Disclosed is a vehicle power-source device provided with a capacitor that stores regenerative power that is output from an alternator, a DC/DC converter having a voltage conversion part that converts an output voltage of the alternator and supplies the converted voltage to a main battery and a load group, a first current sensor that detects discharge current of the capacitor at the time of a regeneration operation, and control parts and that decrease an output voltage setting value to be supplied to a voltage conversion part, based on reception of a discharge current detection signal that is output from the first current sensor.

### CROSS-REFERENCE TO RELATED APPLICATIONS

This application is the U.S. national stage of PCT/JP2016/053336 filed Feb. 4, 2016, which claims priority of Japanese Patent Application No. JP 2015-020891 filed Feb. 5, 2015.

### TECHNICAL FIELD

The present invention relates to a vehicle power-source device provided with an energy regeneration system and a control method for a vehicle power-source device.

### BACKGROUND

In recent years, cars provided with an energy regeneration system have been brought into practical use, in order to reduce fuel consumption of cars. Some energy regeneration systems store power generated by operating an alternator with inertial energy produced at the time when the car is decelerating in a capacitor and a main battery, and drive a starter motor with power stored in the capacitor at the time of restarting the engine following an idling stop. The output torque of the engine is also supplemented by operating a motor with the stored power of the capacitor at the time when the car is running.

As a result of such operations, power consumption of the main battery is reduced by utilizing a capacitor which has excellent charging efficiency, thus allowing the operation time of the alternator to be shortened at the time when the car is running normally. Also, with a car provided with a hybrid system, the output torque of the engine is supplemented with a motor that operates with power from a capacitor, thus allowing the load on the engine to be reduced and a reduction in fuel consumption to be achieved.

FIG. 4 shows an example of a vehicle power-source device provided with a regeneration system such as the above. Power that is generated with an ISG (integrated starter generator) unit 3 provided with the functions of a starter motor 1 and an alternator 2 is used to charge a capacitor 4, as well as being supplied to the main battery 6 and the load group 7 after being stepped down with a DC/DC converter 5. The output power of the DC/DC converter 5 is controlled by a power source control ECU based on the power that is required by a main battery 6 and a load group 7.

The alternator 2 mainly operates and generates power at the time of deceleration under the control of the power source control ECU. The generated power of the alternator 2 is supplied to the capacitor 4, as well as being supplied to the main battery 6 and the load group 7 via the DC/DC converter 5.

JP 2012-60723A discloses a DC/DC converter capable of detecting anomalies with the output current of a voltage transformation part. JP 2002-315313A discloses a DC/DC converter capable of stabilizing output voltage.

As shown in FIG. 5, with vehicle power-source devices such as the above, an output power Q of the alternator 2 decreases as the speed of the car decreases, at the time of the regeneration operation. Also, the DC/DC converter 5 is controlled by the power source control ECU to output a constant power P at a constant output voltage Vc, such as a voltage of 15V in order to supply charge current to the main battery 6, for example.

Then, in a region HP where the output power Q of the alternator 2 is greater than the output power P of the DC/DC converter 5, charge current is supplied to the main battery 6 based on the output power Q of the alternator 2, as well as required power being supplied to the load group 7.

On the other hand, in a region LP where the output power Q of the alternator 2 is less than the output power P of the DC/DC converter 5, charge current is supplied to the main battery 6, using the charging power of the capacitor 4.

Accordingly, with the DC/DC converter 5, power is transferred from the capacitor 4 to the main battery 6, when the output power Q of the alternator 2 decreases, and power efficiency decreases. This is because of the main battery 6 being constituted by a lead battery which has inferior charging efficiency.

Also, since the charging operation and the discharging operation are repeatedly performed in the capacitor 4 whenever the car shifts to the regeneration operation, there is a problem in that the capacitor 4 readily deteriorates. With the DC/DC converters disclosed in JP 2012-60723A and JP 2002-315313A, a configuration for using the DC/DC converter in the regeneration system to improve the power efficiency of the car is not disclosed.

### SUMMARY

This invention was made in view of such a situation, and an object thereof is to provide a vehicle power-source device that can improve power efficiency by suppressing discharge of a capacitor based on the decrease in output power of an alternator.

A vehicle power-source device according to one aspect of the present invention includes a capacitor configured to store regenerative power that is output from an alternator, a DC/DC converter having a voltage conversion part configured to convert an output voltage of the alternator and supply the converted voltage to a main battery and a load group, a first current sensor configured to detect discharge current of the capacitor at a time of a regeneration operation, and a control part configured to decrease an output voltage setting value to be supplied to the voltage conversion part, based on reception of a discharge current detection signal that is output from the first current sensor.

According to this configuration, when discharge current flows to the DC/DC converter from the capacitor at the time of the regeneration operation, the output voltage of the DC/DC converter is lowered and charge current to the main battery is suppressed.

The vehicle power-source device preferably includes a second current sensor configured to detect charge current that is supplied to the main battery from the DC/DC converter, and the control part preferably decreases an output voltage of the voltage conversion part to a level at which the charge current is not supplied to the main battery, based on the discharge current detection signal and a charge current detection signal that is output from the second current sensor.

According to this configuration, when discharge current flows to the DC/DC converter from the capacitor at the time of the regeneration operation, charge current from the DC/DC converter to the main battery is interrupted.

The control part preferably includes a power source control ECU configured to output a command signal to the DC/DC converter, based on reception of the discharge current detection signal, and a microcomputer provided in the DC/DC converter and configured to decrease the output voltage of the voltage conversion part based on the command signal.

According to this configuration, when a discharge current detection signal is output from the first current sensor and the charge current detection signal is output from the second current sensor at the time of the regeneration operation, the output voltage of the DC/DC converter is lowered due to operation of the power source control ECU and the microcomputer, and the charge current to the main battery is interrupted.

A control method for a vehicle power-source device according to one aspect of the present invention includes decreasing an output voltage of a DC/DC converter configured to supply charge current to a main battery based on discharge current of a capacitor, when the discharge current is detected at a time of a regeneration operation.

According to this method, when the discharge current of the capacitor flows at the time of the regeneration operation, charge current from the DC/DC converter to the main battery is suppressed.

In the control method, preferably the output voltage of the DC/DC converter is decreased to a voltage at which the charge current is interrupted, based on detection of the charge current.

According to this method, when discharge current flows to the DC/DC converter from the capacitor at the time of the regeneration operation, charge current from the DC/DC converter to the main battery is interrupted.

### ADVANTAGEOUS EFFECTS OF INVENTION

According to some aspects of the present invention, a vehicle power-source device that improves power efficiency by suppressing discharge of a capacitor that is based on a decrease in the output power of an alternator can be provided. Other aspects and advantages of the present invention will become apparent from the following description taken in conjunction with the accompanying drawings, which show by way of example the technical idea of the invention.

### BRIEF DESCRIPTION OF DRAWINGS

FIG. 1 is a block diagram showing a vehicle power-source device according to a first embodiment.

FIG. 2 is a timing chart for illustrating operations of the vehicle power-source device of the first embodiment.

FIG. 3 is a flowchart showing operations of the vehicle power-source device.

FIG. 4 is an illustrative diagram showing a conventional vehicle power-source device.

FIG. 5 is a timing chart for illustrating operation of the conventional vehicle power-source device.

### DETAILED DESCRIPTION OF PREFERRED EMBODIMENTS

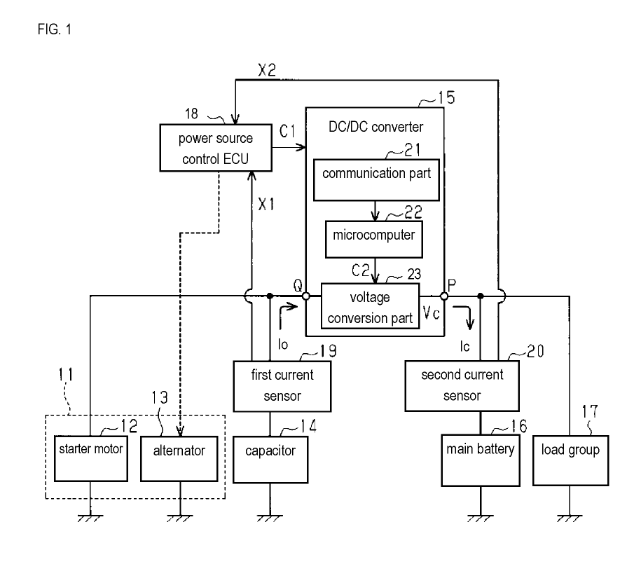

Hereinafter, one embodiment of a vehicle power-source device will be described in accordance with the drawings. An ISG unit 11 of the vehicle power-source device shown in FIG. 1 is provided with the functions of a starter motor 12 and an alternator 13. When the ISG unit 11 operates as the alternator 13, a capacitor 14 is charged with an output power Q.

Also, the output power Q that is output from the alternator 13 is supplied to a main battery 16 and a load group 17 after being stepped down with a DC/DC converter 15.

The alternator 13 is controlled by a power source control ECU 18 based on the amount of charge of the capacitor 14 and the main battery 16, and operates to generate power based mainly on inertial energy produced at the time when a car is decelerating.

The starter motor 12 is controlled by an engine control ECU (not shown), and operates at the time of starting an engine and at the time of restarting the engine following an idling stop. Normally the starter motor 12 operates based on power that is supplied from the capacitor 14.

A first current sensor 19 is interposed between the capacitor 14 and the DC/DC converter 15. This first current sensor 19 outputs a discharge current detection signal X1 to the power source control ECU 18, when a discharge current Io that flows toward the DC/DC converter 15 from the capacitor 14 is detected.

A second current sensor 20 is interposed between the DC/DC converter 15 and the main battery 16. This second current sensor 20 outputs a charge current detection signal X2 to the power source control ECU 18, when a charge current Ic that flows to the main battery 16 from the DC/DC converter 15 is detected.

The power source control ECU 18 operates based on the discharge current detection signal X1, the charge current detection signal X2, and a program set in advance at the time of the regeneration operation, and operates so as to prevent the charging operation of the main battery 16 that uses the stored power of the capacitor 14.

Specifically, the power source control ECU 18 shifts to a discharge suppression mode for suppressing discharge of the capacitor 14 based on the input of the discharge current detection signal X1. In the discharge suppression mode, the power source control ECU 18 outputs a command signal C1 for lowering an output voltage Vc of a voltage conversion part 23 to the DC/DC converter 15, based on the detection signal X2, so as to prevent inflow of the charge current Ic to the main battery 16.

The DC/DC converter 15 is provided with a communication part 21 that performs a communication operation with the power source control ECU 18, a microcomputer 22 that operates based on the program that is set in advance, and a voltage conversion part 23 that adjusts the output voltage Vc and an output power P by adjusting the duty ratio of PWM control, using an output voltage setting value C2 that is output from the microcomputer 22.

The DC/DC converter 15 supplies a constant output power P to the main battery 16 and the load group 17, while stepping down the output voltage of the alternator 13 to a predetermined voltage.

Next, the action of a vehicle power-source device provided with a DC/DC converter 15 such as the above will be described.

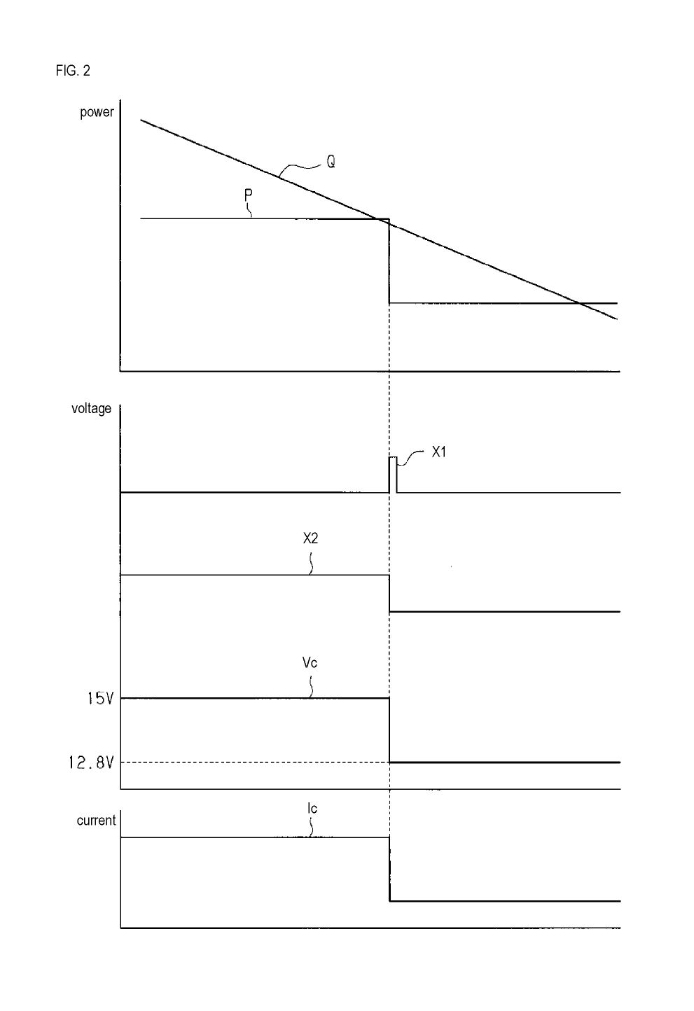

As shown in FIG. 2, although the output power Q of the alternator 13 gradually decreases with a decrease in the speed of the car at the time of the regeneration operation, the DC/DC converter 15 outputs a constant output power P that is set in advance. The main battery 16 is charged using this output power P, and required power is supplied to the load group 17.

When the output power Q is less than the output power P, the discharge current Io starts flowing to the DC/DC converter 15 from the capacitor 14. Then, the first current sensor 19 detects the discharge current Io and outputs the discharge current detection signal X1 to the power source control ECU 18.

The power source control ECU 18 shifts to the discharge suppression mode based on reception of the discharge current detection signal X1. Then, in the discharge suppression mode, when the second current sensor 20 is outputting the detection signal X2 after detecting charge current to the main battery 16, the power source control ECU 18 outputs the command signal C1 to the microcomputer 22 of the DC/DC converter 15, based on reception of the detection signal X2.

The microcomputer 22 outputs the output voltage setting value C2 to the voltage conversion part 23 based on reception of the command signal C1. Then, in the voltage conversion part 23, the duty ratio of PWM control is changed, and the output voltage Vc that the voltage conversion part 23 is going to output, for example, is suppressed so as to decrease from the constant voltage (e.g., approx. 15V) for charging the main battery 16 to around 12.8V which is the normal output voltage of the main battery 16.

As a result, the output power P of the DC/DC converter 15 decreases to less than the output power Q of the alternator 13. In this state, the discharge current Io of the capacitor 14 and the charge current Ic to the main battery 16 are interrupted.

Thereafter, the output voltage Vc of the voltage conversion part 23 is maintained at substantially the same potential as the output voltage of the main battery 16, even when the output power Q of the alternator 13 decreases, and thus the charge current Ic is interrupted, regardless of the output power Q of the alternator 13. Required power is then substantially supplied to the load group 17 from the main battery 16.

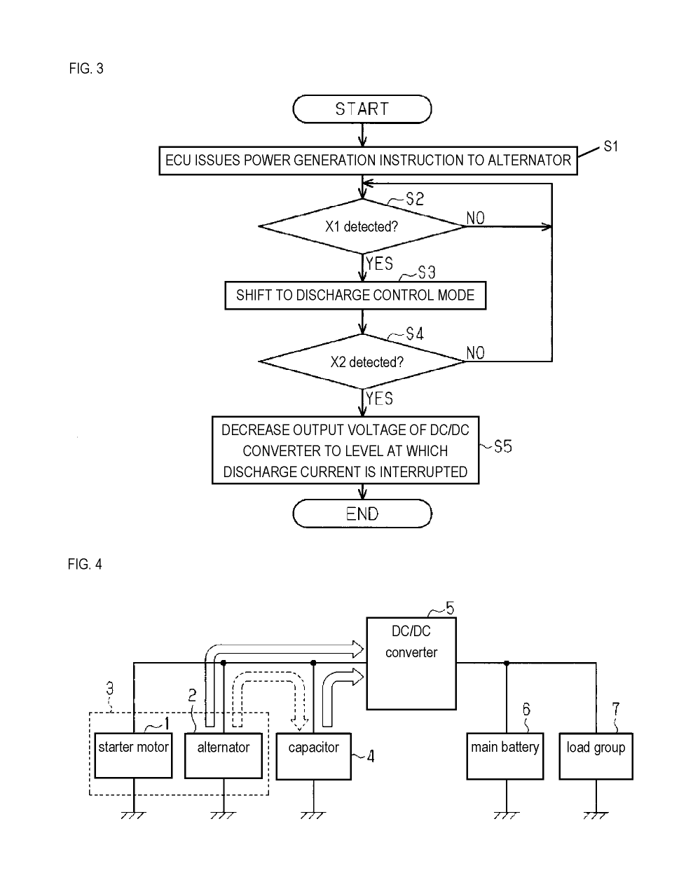

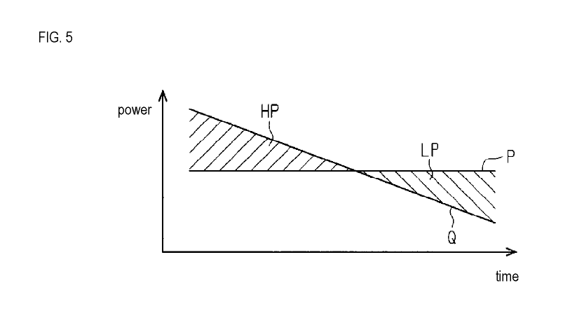

FIG. 3 shows operations of the vehicle power-source device at the time of a regeneration operation such as the above. At the time of the regeneration operation, the power source control ECU 18 issues a power generation instruction to the alternator 13 (step S1), and detects whether the discharge current detection signal X1 and the charge current detection signal X2 from the first and second current sensors 19 and 20 have been received.

In a state in which the output power Q of the alternator 13 is greater than the output power of the DC/DC converter 15, only the detection signal X2 is output, and the discharge current detection signal X1 is not output. When the discharge current detection signal X1 is detected, the power source control ECU 18 shift to the discharge suppression mode (step S3), and determines whether the detection signal X2 is detectable (step S4).

Because a state in which the charge current Ic is being supplied to the main battery 16 using the discharge current Io of the capacitor 14 is entered when the detection signal X2 is detected at step S4, the power source control ECU 18 outputs the command signal C1 for lowering the output voltage Vc of the DC/DC converter 15.

Then, in the DC/DC converter 15, the output voltage setting value C2 that is output to the voltage conversion part 23 from the microcomputer 22 is adjusted, and the output voltage Vc is lowered (step S5). As a result, the discharge current Io from the capacitor 14 and the charge current Ic to the main battery 16 are interrupted.

When the vehicle returns to running normally after the regeneration operation has ended, the command signal C1 and the output voltage setting value C2 are reset in the power source control ECU 18, and the DC/DC converter 15 returns to a state of outputting the normal output voltage Vc and the output power P.

The effects indicated below can be obtained with a vehicle power-source device such as the above.
(1) At the time of the regeneration operation, the charge current Ic that is supplied to the main battery 16 from the capacitor 14 via the DC/DC converter 15 can be interrupted. Accordingly, generation of a power loss that occurs when transferring the charging power of the capacitor 14 to the main battery 16 can be prevented, enabling the power efficiency of the vehicle power-source device to be improved.
(2) Because consumption of the stored power of the capacitor 14 can be suppressed at the time of the regeneration operation, the stored power of the capacitor 14 can be reliably secured for times such as when restarting the engine following the regeneration operation.
(3) Because consumption of the stored power of the capacitor 14 can be suppressed at the time of the regeneration operation, the alternator 13 does not need to be operated apart from at the time of the regeneration operation in order to charge the capacitor 14. Accordingly, a fuel consumption reduction effect can be secured.

Note that the above embodiment may be changed as follows.

In the example of FIG. 1, the power source control ECU 18 and the microcomputer 22 are configured to function in tandem as a control part. For example, the power source control ECU 18 may directly control the voltage conversion part 23 of the DC/DC converter, based on the discharge current detection signal X1 and the charge current detection signal X2. Alternatively, the microcomputer 22 may receive the discharge current detection signal X1 and the charge current detection signal X2, and directly control the voltage conversion part 23. The power source control ECU 18 and the microcomputer 22 may be realized by a plurality of individual computers that each include a memory and a processor, as long as the individual computers are configured to function in tandem as a control part, or a single computer may realize the functions of the power source control ECU 18 and the microcomputer 22. Accordingly, the vehicle power-source device can include at least one memory and one or more processors that can access the memory. The at least one memory can include computer-executable commands configured to realize the functions, methods or configurations described in the aforementioned embodiment when executed by the one or more processors. Accordingly, the present invention includes a recording medium (also called a non-transitory medium) that stores computer-executable commands configured to realize the functions, methods or configurations described in the aforementioned embodiment. The computer-readable medium may be any suitable medium that the one or more computer processors are able to access, and can, for example, include a digital memory such as a RAM, a ROM or an EEPROM, a CD-ROM or other optical disc storage, a magnetic-disk storage or other magnetic storage device, and a suitable combination thereof.

The present invention is not limited to that illustrated above. For example, the illustrated features should not be interpreted as being essential to the invention, and the subject matter of the invention may be present in fewer than all of the features of disclosed specific embodiments. Therefore, the scope of the invention is to be determined, not by reference to illustrated embodiments, but by reference to the claims together with all equivalents thereof.

1. A vehicle power-source device comprising:
a capacitor configured to store regenerative power that is output from an alternator;
a DC/DC converter having a voltage conversion part configured to convert an output voltage of the alternator and supply the converted voltage to a main battery and a load group;
a first current sensor configured to detect discharge current of the capacitor at a time of a regeneration operation;
a second current sensor configured to detect charge current that is supplied to the main battery from the DC/DC converter; and
a control part configured to decrease an output voltage of the voltage conversion part to a level at which the charge current is not supplied to the main battery, by decreasing an output voltage setting value to be supplied to the voltage conversion part, when both a discharge current detection signal that is produced when output power of the alternator decreases to less than output power of the DC/DC converter during the regeneration operation of the alternator and that is output from the first current sensor and a charge current detection signal that is output from the second current sensor are received during the regeneration operation of the alternator.

2. (canceled)

3. The vehicle power-source device according to claim 1,
wherein the control part includes:
a power source control ECU configured to output a command signal to the DC/DC converter, based on reception of the discharge current detection signal; and
a microcomputer provided in the DC/DC converter, and configured to output an output voltage setting value for decreasing the output voltage of the voltage conversion part based on the command signal.

4. A control method for a vehicle power-source device that includes a capacitor configured to store regenerative power that is output from an alternator and a DC/DC converter having a voltage conversion part configured to convert an output voltage of the alternator and supply the converted voltage to a main battery and a load group, the method comprising:
decreasing an output voltage of the voltage conversion part to a level at which the charge current is not supplied to the main battery, by decreasing an output voltage setting value to be supplied to the voltage conversion part, when both a discharge current of a the capacitor that is produced when output power of the alternator decreases to less than output power of the DC/DC converter at a time of a regeneration operation of the alternator and charge current that is supplied to the main battery from the DC/DC converter are detected.

5. (canceled)
